(19) United States
(12) Patent Application Publication
(10) Pub. No.: US 2025/0323591 A1
(43) Pub. Date: Oct. 16, 2025

(54) CONTROL DEVICE AND METHOD FOR ADJUSTING SPEED AND FORWARD/REVERSE ROTATION OF A WIRE-CONTROLLED BRUSHLESS MOTOR POWER SUPPLY DURING POSITIVE/NEGATIVE HALF-CYCLE PHASE LOSS

(71) Applicant: Rhine Electronic Co., Ltd., Taichung City (TW)

(72) Inventor: Yi-Kai Chang, Taichung City (TW)

(21) Appl. No.: 19/248,726

(22) Filed: Jun. 25, 2025

Related U.S. Application Data
(63) Continuation-in-part of application No. 18/451,544, filed on Aug. 17, 2023.

(30) Foreign Application Priority Data
Aug. 4, 2023 (TW) 112129454

(51) Int. Cl. H02P 27/04; H02P 23/24; H02P 25/03

(52) U.S. Cl. CPC H02P 27/04; H02P 23/24; H02P 25/03

(57) ABSTRACT

The present invention relates to a control device and method for adjusting speed and forward/reverse rotation of a wire-controlled brushless motor power supply during positive/negative half-cycle phase loss, comprising an AC power supply, a wire-controlled circuit control device, an equipment-side control device, and a ceiling fan brushless motor, wherein the AC power supply is electrically connected to the wire-controlled circuit control device which is electrically connected to the equipment-side control device and which is electrically connected to the ceiling fan brushless motor, to control the AC power supply positive/negative half-cycle on/off and to generate a positive/negative half-cycle signal for multi-step speed and forward/reverse rotation control, detection, determination, and storage. The overall design is simple and convenient without the need for complicated and cumbersome wiring or safety concerns, to achieve the effect of structural stability and the use of safety and convenience.

### CROSS REFERENCE TO RELATED APPLICATIONS

This application is a Continuation-in-Part of co-pending application Ser. No. 18/451,544, filed on Aug. 17, 2023, for which priority is claimed under 35 U.S.C. § 120; and this application claims priority of application Ser. No. 11/212,9454 filed in Taiwan on Aug. 4, 2023 under 35 U.S.C. § 119; the entire contents of all of which are hereby incorporated by reference.

### FIELD OF INVENTION

The present invention is a control device and method for adjusting speed and forward/reverse rotation of a wire-controlled brushless motor power supply during positive/negative half-cycle phase loss, more particularly concerning the application in the technical field of a ceiling fan brushless motor wire-controlled device.

### BACKGROUND OF THE INVENTION

As shown in FIG. 11, the presently known structure for wired-controlled ceiling fans comprises an AC power supply 100, an equipment-side control device 20, a ceiling fan brushless motor 30, and a wall switch 40. Wherein the AC power supply 100 is electrically connected to the wall switch 40, which is further connected to the equipment-side control device 20. Meanwhile, the equipment-side control device 20 is electrically connected to the ceiling fan brushless motor 30, through which the wall switch 40 inputs and transmits a control signal to the equipment-side control device 20 to regulate the ceiling fan brushless motor 30. However, this arrangement cannot switch between different speeds and also cannot control directional airflow, including both upward and downward airflow achieved by forward and reverse rotation. To achieve the aforementioned control functions, the existing structure requires complicated wiring, resulting in a relatively complex and inconvenient installation and structure. Therefore, there is a need for improvement in this respect.

### SUMMARY OF THE INVENTION

Given the problems of structural stability and poor convenience in the use of the conventional wire-controlled ceiling fan structure, the present invention has completed a control device and method for adjusting speed and forward/reverse rotation of a wire-controlled brushless motor power supply during positive/negative half-cycle phase loss.

The main purpose of the present invention is to provide the control device and method for adjusting speed and forward/reverse rotation of a wire-controlled brushless motor power supply during positive/negative half-cycle phase loss, which is applied to an AC power supply and a ceiling fan brushless motor, comprising: a wire-controlled circuit control device and an equipment-side control device, the wire-controlled circuit control device being provided with a wire-controlled microcontroller unit, a positive/negative half-cycle control unit, a wire-controlled power unit, and at least one control key unit, wherein the wire-controlled microcontroller unit being electrically connected to the positive/negative half-cycle control unit, the wire-controlled power unit, and the control key unit, respectively, and wherein the equipment-side control device being provided with an equipment-side microcontroller unit, a positive half-cycle detector, a negative half-cycle detector, a brushless motor power unit, and a brushless motor drive unit, the equipment-side microcontroller unit being electrically connected to the positive half-cycle detector, the negative half-cycle detector, and the brushless motor drive unit, respectively, and the brushless motor power unit being electrically connected to the positive half-cycle detector, the negative half-cycle detector, and the equipment-side microcontroller unit, respectively. Wherein the AC power supply is electrically connected to the positive/negative half-cycle control unit, and the wire-controlled power unit of the wire-controlled circuit control device, and the positive/negative half-cycle control unit of the wire-controlled circuit control device is electrically connected to the positive half-cycle detector, the negative half-cycle detector, and the brushless motor power unit of the equipment-side control device, and the brushless motor drive unit is electrically connected to the ceiling fan brushless motor, whereby the wire-controlled microcontroller unit of the wire-controlled circuit control device stores AC positive/negative half-cycle phase loss waveforms, phase loss duration, or phase loss frequency, corresponding to the control logic conditions for step speed and forward/reverse rotation; upon operating the control key unit to select control commands for step speed and forward/reverse rotation, the wire-controlled circuit control device and the equipment-side control device detect power supply, and the AC power introduced by the wire-controlled circuit control device is processed by the wire-controlled microcontroller to match the introduced AC power with the stored control logic conditions for step speed and forward/reverse rotation, and the selected control logic conditions for step speed and forward/reverse rotation, corresponding to the control signals of positive/negative half-cycle phase loss waveforms, phase loss duration, or phase loss frequency, are transmitted to the positive/negative half-cycle control unit, so that the control signals of positive/negative half-cycle phase loss waveforms, phase loss duration, or phase loss frequency are input through the positive half-cycle detector and negative half-cycle detector of the equipment-side control device to the equipment-side microcontroller unit for signal confirmation, and the confirmed control signals are transmitted to the brushless motor drive unit to control the step speed and forward/reverse rotation of the ceiling fan brushless motor.

In a preferred embodiment, the wire-controlled microcontroller unit of the wire-controlled circuit control device is an MCU (Microcontroller Unit), and the wire-controlled microcontroller unit is a microcomputer integrated with a central processor, a memory, etc., which enables the storage of the positive/negative half-cycle signals for controlling the on/off after the current/voltage in the AC power supply inputs to the wire-controlled circuit control device, thereby effectively simplifying the complexity of the wiring and increasing the multi-applicability of the present invention.

In a preferred embodiment, the positive/negative half-cycle control unit of the wire-controlled circuit control device is provided with a positive half-cycle switch control element and a negative half-cycle switch control element, and both of them are cooperated with a relay and a diode and are electrically connected to the AC power supply, which enables the control of the on/off input signals from the current/voltage without the need for control by complicated wiring, to increase the multi-applicability of the present invention.

In a preferred embodiment, the positive/negative half-cycle control unit of the wire-controlled circuit control device is provided with a switch control unit which is a bidirectional thyristor (TRIAC) and is electrically connected to the AC power supply, which enables the control of the on/off input signals from the current/voltage without the need for control by complicated wiring, to increase the multi-applicability of the present invention.

In a preferred embodiment, the positive/negative half-cycle control unit of the wire-controlled circuit control device includes a switch control unit, wherein the switch control unit is a silicon-controlled rectifier (SCR) switch, electrically connected to the AC power supply, which enables the control of the on/off input signals from the current/voltage of the AC power supply without the need for control by complicated wiring, thereby enhancing the versatility of the present invention.

In a preferred embodiment, the equipment-side microcontroller unit of the equipment-side control device is a microcontroller unit (MCU), which is a microcomputer integrated with a central processor, a memory, a timer/counter, etc., to receive positive/negative half-cycle phase loss signals from the wire-controlled circuit control device and to cooperate with the timing or interval signals generated by the timer/counter to perform an interpretation and to form the multi-step speed control signals or forward/reverse rotation control signals for storage, which are used to control the switching of the step speed and the forward/reverse rotation of the ceiling fan brushless motor by the control signals, thereby effectively simplifying the complexity of the wiring and increasing the multi-applicability of the present invention.

In a preferred embodiment, the invention is further applied to an LED lamp, wherein the equipment-side control device further includes an LED lamp power unit and an LED lamp drive unit, wherein the equipment-side microcontroller unit is further electrically connected to the LED lamp power unit and the LED lamp drive unit, and the LED lamp power unit is electrically connected to the LED lamp drive unit, which is further electrically connected to the LED lamp. Through the wire-controlled microcontroller unit of the wire-controlled circuit control device, control logic conditions are stored, comprising positive or negative half-cycle phase loss waveforms, phase loss duration, or phase loss frequency, corresponding to LED lamp deactivation, LED lamp brightness variation, and color temperature variation.

The equipment-side control device determines whether the LED lamp is powered on. If it detects that the LED lamp is not powered on, the LED lamp power drive unit is deactivated. Upon operating the control key unit to select control commands for LED lamp brightness variation and color temperature variation, the wire-controlled circuit control device, via the wire-controlled microcontroller, correlates the input AC power with the stored control logic conditions for LED lamp brightness and color temperature variation, and selects the control logic conditions for LED lamp brightness variation and color temperature variation, corresponding to control signals of positive or negative half-cycle phase loss waveforms, phase loss duration, or phase loss frequency. These control signals are transmitted to the positive or negative half-cycle control unit, and the control signals of positive or negative half-cycle phase loss waveforms, phase loss duration, or phase loss frequency are passed through the positive half-cycle detector and negative half-cycle detector of the equipment-side control device to the equipment-side microcontroller unit for signal confirmation. The confirmed control signals are transmitted to the LED lamp drive unit to control the LED lamp's brightness variation and color temperature variation. The control method operates as follows: upon initiation, proceed to step S201 where the control key unit of the wire-controlled circuit control device controls whether the positive or negative half-cycle control unit experiences positive or negative half-cycle phase loss; if the positive half-cycle detector detects positive half-cycle phase loss or the negative half-cycle detector detects negative half-cycle phase loss, the wire-controlled circuit control device determines to proceed to step S202 or step S203. In step S202, the equipment-side control device determines, based on the detected positive or negative half-cycle phase loss, whether it corresponds to the control logic conditions for the ceiling fan motor; if it corresponds to the ceiling fan motor's control logic conditions, proceed to step S202A where the brushless motor drive unit controls the ceiling fan brushless motor's step speed, forward/reverse rotation, or deactivation according to the control logic conditions.

In step S203, the equipment-side control device determines, based on the detected positive or negative half-cycle phase loss, whether it corresponds to the control logic conditions for the LED lamp; if it corresponds to the LED lamp's control logic conditions, proceed to step S203A where the LED lamp drive unit controls the LED lamp's brightness, color temperature, or deactivation according to the control logic conditions. If neither the positive half-cycle detector detects positive half-cycle phase loss nor the negative half-cycle detector detects negative half-cycle phase loss, the wire-controlled circuit control device proceeds to step S201A, where the brushless motor drive unit controls the ceiling fan brushless motor based on the existing step speed, forward/reverse rotation, or deactivation, while the LED lamp drive unit controls the LED lamp based on the existing brightness, color temperature, or deactivation, thereby enhancing the overall applicability of the device and increasing the multi-applicability of the present invention.

By cooperating with the AC power supply, the wire-controlled circuit control device, the equipment-side control device, and the ceiling fan brushless motor, wherein the AC power supply is electrically connected to the wire-controlled circuit control device, and the AC power supply inputs current/voltage in the power source to the wire-controlled circuit control device to control the on/off of the positive/negative half-cycle of the AC power supply with the wire-controlled circuit control device, and the wire-controlled circuit control device is electrically connected to the equipment-side control device; the positive/negative half-cycle phase loss signals derived from the wire control circuit control device is detected and controlled by the equipment-side control device and interpreted in accordance with the length of the positive half-cycle loss time only or the frequency of the positive half-cycle loss time only, and the length of the negative half-cycle loss time only or the frequency of the negative half-cycle loss time only, to generate the control information of the multi-step speed or forward/reverse rotation setting for the memory storage; and the equipment-side control device is electrically connected to the ceiling fan brushless motor, the equipment-side control device generates the control signals and transmits it to the ceiling fan brushless motor to perform the multi-step speed and forward/reverse rotation control. The overall arrangement is simple and convenient, without complicated wiring, which achieves the effect of structural stability and convenience in use.

### BRIEF DESCRIPTION OF THE DRAWINGS

FIG. 1 is a reference diagram of the state of the overall composition of a control device for adjusting speed and forward/reverse rotation of a wire-controlled brushless motor power supply during positive/negative half-cycle phase loss of the present invention;

FIG. 2 is a reference diagram of the state of the detailed composition of the control device for adjusting speed and forward/reverse rotation of a wire-controlled brushless motor power supply during positive/negative half-cycle phase loss of the present invention;

FIG. 3 is a reference diagram of the state of the control flow of the control device for adjusting speed and forward/reverse rotation of a wire-controlled brushless motor power supply during positive/negative half-cycle phase loss of the present invention;

FIG. 4 is a reference diagram of the detection state of the control device for adjusting speed and forward/reverse rotation of a wire-controlled brushless motor power supply during positive/negative half-cycle phase loss of the present invention;

FIG. 5 is a reference diagram of the detection state of the positive/negative half-cycle and the phase loss cooperated with the time interval of the normal operation detection of the wire-controlled circuit control device and the equipment-side control device of the control device for adjusting speed and forward/reverse rotation of a wire-controlled brushless motor power supply during positive/negative half-cycle phase loss of the present invention;

FIG. 6 is a reference diagram of the state for the first embodiment of a positive/negative half-cycle control unit having a positive half-cycle switching control element and a negative half-cycle switching control element cooperated with a relay and a diode provided in the wire-controlled circuit control device of the control device for adjusting speed and forward/reverse rotation of a wire-controlled brushless motor power supply during positive/negative half-cycle phase loss of the present invention;

FIG. 7 is a reference diagram of the state for the second embodiment of the control device for adjusting speed and forward/reverse rotation of a wire-controlled brushless motor power supply during positive/negative half-cycle phase loss of the present invention, illustrating a switch control unit comprising a bidirectional thyristor (TRIAC);

FIG. 8 is a reference diagram of the state for the third embodiment of the control device for adjusting speed and forward/reverse rotation of a wire-controlled brushless motor power supply during positive/negative half-cycle phase loss of the present invention, illustrating a switch control unit comprising a silicon-controlled rectifier (SCR);

FIG. 9 is a reference diagram of the state for the fourth embodiment of the control device for adjusting speed and forward/reverse rotation of a wire-controlled brushless motor power supply during positive/negative half-cycle phase loss of the present invention, illustrating the control state with an additional lamp fixture;

FIG. 10 is a reference diagram of the control flow state for the fourth embodiment of the control device for adjusting speed and forward/reverse rotation of a wire-controlled brushless motor power supply during positive/negative half-cycle phase loss of the present invention, illustrating the control method for a lamp fixture; and

FIG. 11 is a reference diagram of the prior art ceiling fan wire-controlled structure for the control method of the control device for adjusting speed and forward/reverse rotation of a wire-controlled brushless motor power supply during positive/negative half-cycle phase loss of the present invention.

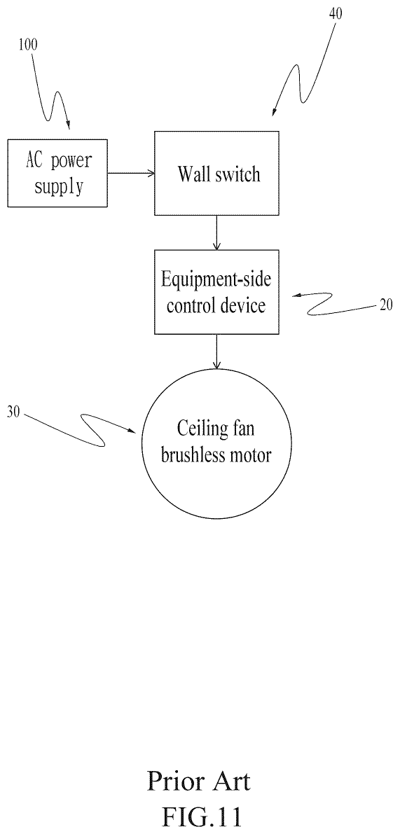

### DETAILED DESCRIPTION OF THE PREFERRED EMBODIMENTS

For a better understanding of the structure, features, and other purposes of the present invention, the following preferred embodiments are illustrated in detail in the accompanying drawings, provided that the embodiments illustrated herein are for illustrative purposes only and are not intended to serve as the sole limitation of the patent application.

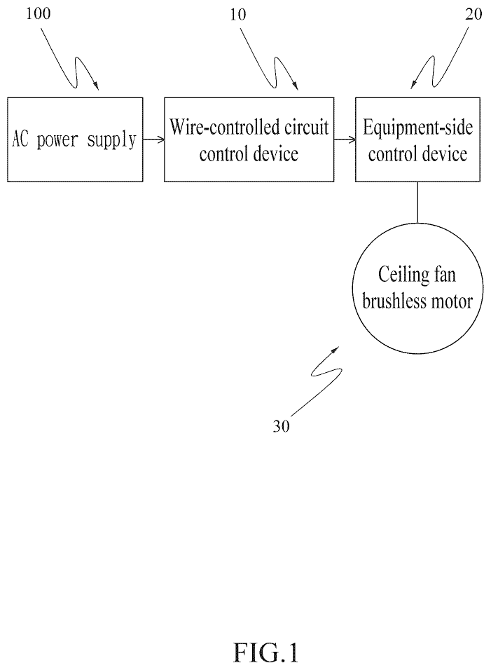

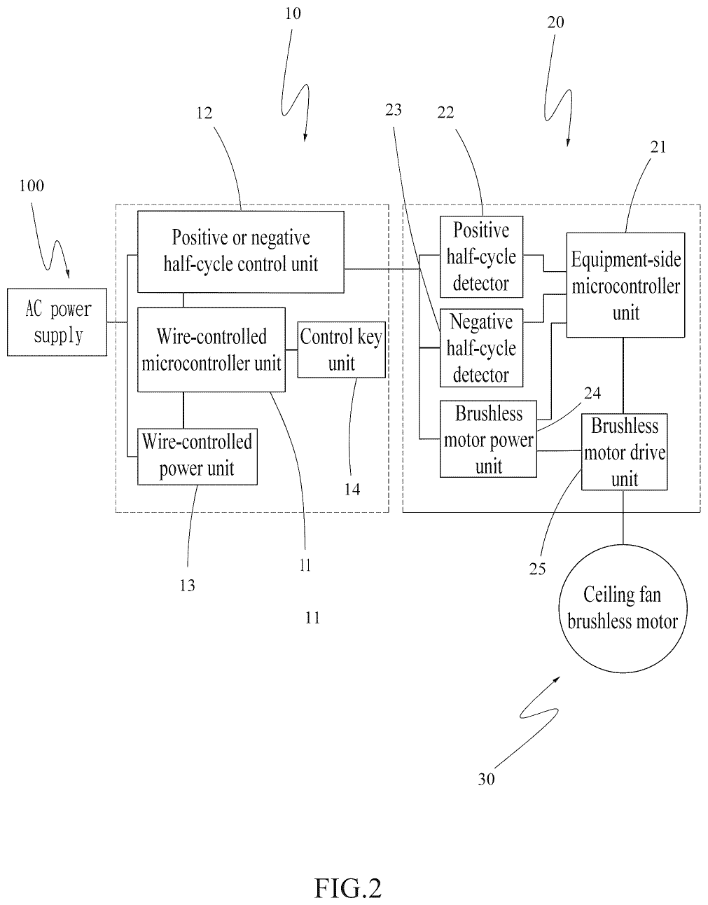

Please refer to FIGS. 1 and 2, which are the reference diagrams of the state of the overall composition and the detailed composition of a control device for adjusting speed and forward/reverse rotation of a wire-controlled brushless motor power supply during positive/negative half-cycle phase loss of the present invention, which is applied to an AC power supply 100 and a ceiling fan brushless motor 30, and which comprises:
a wire-controlled circuit control device 10, which is provided with a wire-controlled microcontroller unit 11, a positive/negative half-cycle control unit 12, a wire-controlled power unit 13, and at least one control key unit 14, wherein the wire-controlled microcontroller unit 11 is electrically connected to the positive/negative half-cycle control unit 12, the wire-controlled power unit 13, and the control key unit 14, respectively, and wherein the AC power supply 100 is electrically connected to the positive/negative half-cycle control unit 12, and the wire-controlled power unit 13 of the wire-controlled circuit control device 10; and
an equipment-side control device 20, which is provided with an equipment-side microcontroller unit 21, a positive half-cycle detector 22, a negative half-cycle detector 23, a brushless motor power unit 24, and a brushless motor drive unit 25, wherein the equipment-side microcontroller unit 21 is electrically connected to the positive half-cycle detector 22, the negative half-cycle detector 23, and the brushless motor drive unit 25, respectively, and the brushless motor power unit 24 is electrically connected to the positive half-cycle detector 22, the negative half-cycle detector 23, the brushless motor drive unit 25, and the equipment-side microcontroller unit 21, respectively; wherein the positive half-cycle detector 22, the negative half-cycle detector 23, and the positive/negative half-cycle control unit 12 of the wire-controlled circuit control device 10 are electrically connected, the brushless motor power unit 24, the equipment-side microcontroller unit 21, and the brushless motor drive unit 25 are electrically connected, and the brushless motor drive unit 25 and the ceiling fan brushless motor 30 are electrically connected.

Through the wire-controlled microcontroller unit 11 of the wire-controlled circuit control device 10, control logic conditions are stored, comprising AC power positive or negative half-cycle phase loss waveforms, phase loss duration, or phase loss frequency, corresponding to speed and forward/reverse rotation control. Upon operating the control key unit 14 to select control commands for step speed and forward/reverse rotation, the wire-controlled circuit control device 10, via the wire-controlled microcontroller 11, correlates the input AC power with the stored control logic conditions for step speed and forward/reverse rotation, and selects the control logic conditions for step speed and forward/reverse rotation, corresponding to control signals of positive or negative half-cycle phase loss waveforms, phase loss duration, or phase loss frequency. These control signals are transmitted to the positive or negative half-cycle control unit 12, and the control signals of positive or negative half-cycle phase loss waveforms, phase loss duration, or phase loss frequency are passed through the positive half-cycle detector 22 and negative half-cycle detector 23 of the equipment-side control device 20 to the equipment-side microcontroller unit 21 for signal confirmation. The confirmed control signals are then transmitted to the brushless motor drive unit 25 to control the step speed and forward/reverse rotation of the ceiling fan brushless motor 30.

With the cooperation of the above structures, accomplish the present invention of the control device for adjusting speed and forward/reverse rotation of a wire-controlled brushless motor power supply during positive/negative half-cycle phase loss.

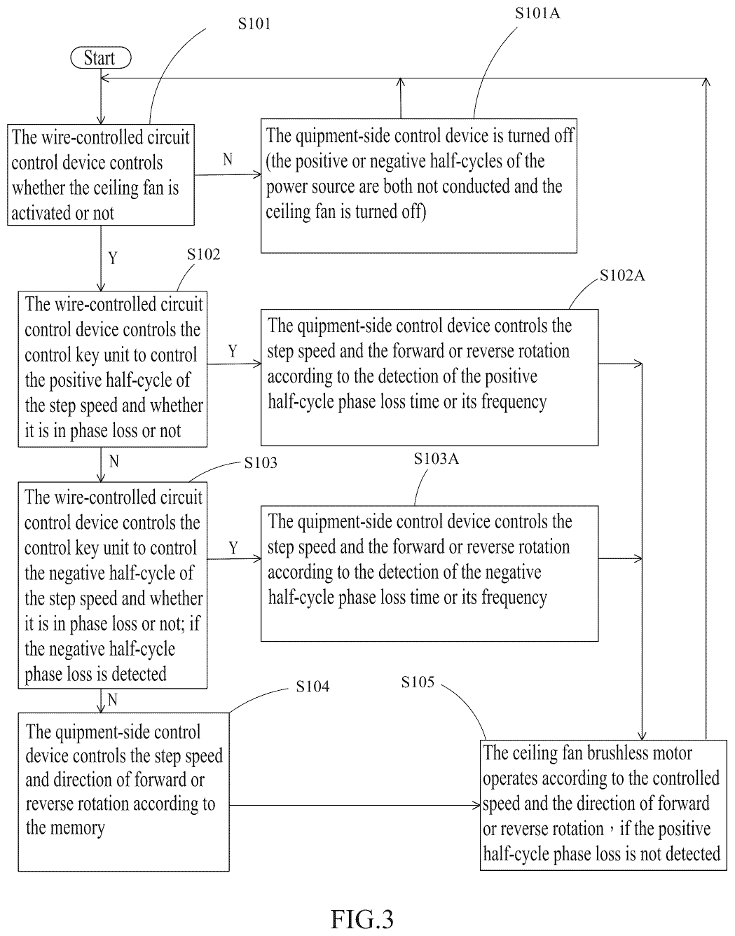

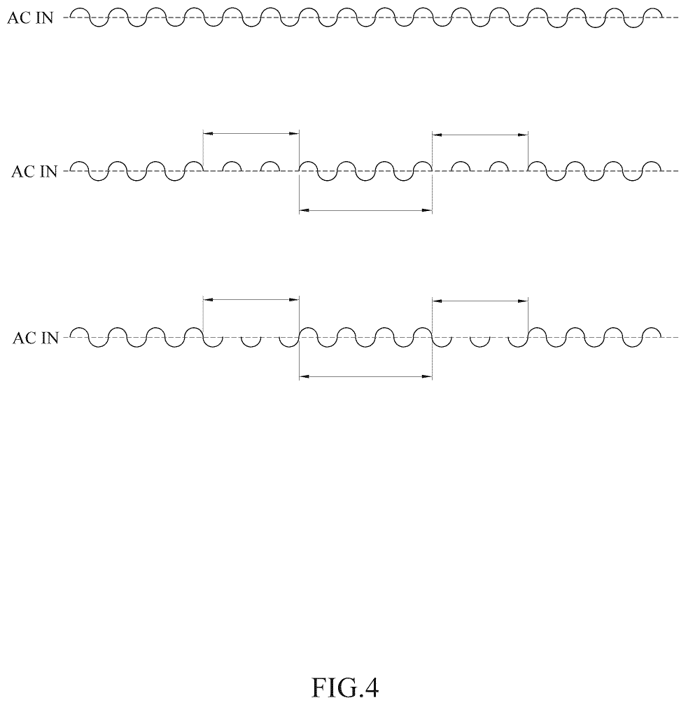

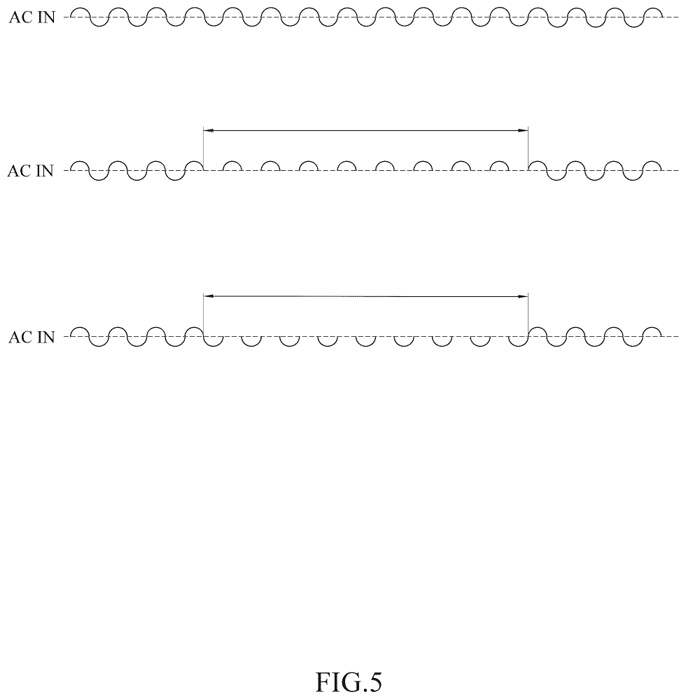

Please refer to FIGS. 1 to 5, which are the reference diagrams of the state of the overall composition, the detailed composition, the control flow, the detection of positive/negative half-cycle and phase loss cooperated with the counting of the normal operation of the wire-controlled circuit control device and the equipment-side control device, and the detection of positive/negative half-cycle and phase loss cooperated with the time interval of the normal operation of the wire-controlled circuit control device and the equipment-side control device of the present invention, comprising an AC power supply 100, a wire-controlled circuit control device 10, an equipment-side control device 20, and a ceiling fan brushless motor 30, wherein the AC power supply 100 is electrically connected to the wire-controlled circuit control device 10, and the AC power supply 100 inputs the current/voltage of the AC power to the wire-controlled circuit control device 10 to control the control signals generated from the positive/negative half-cycle on/off of the AC power supply; the wire-controlled circuit control device 10 is electrically connected to the equipment-side control device 20, the positive/negative half-cycle phase loss signals derived from the wire control circuit control device 10 is detected by the equipment-side control device 20 and interpreted in accordance with the length of the positive half-cycle loss time only or the sequence or the frequency of the negative half-cycle loss time only, to conduct the multi-step speed or forward/reverse rotation control;
the equipment-side control device 20 is electrically connected to the ceiling fan brushless motor 30, and the equipment-side control device 20 generates the control signals and transmits it to the ceiling fan brushless motor 30 to perform the multi-step speed and forward/reverse rotation control. The flow of the control method is that when it starts to operate, it enters into the step S101: the wire-controlled circuit control device controls whether the ceiling fan is activated or not; if it detects that it is not activated, then it enters into the step S101A: the equipment-side control device is turned off (the positive/negative half-cycles of the power source are both not conducted and the ceiling fan is turned off); if it detects that it is activated, then it enters into the step S102: the wire-controlled circuit control device controls the control key unit to control the positive half-cycle of the step speed and whether it is in phase loss or not; if it detects that the positive half-cycle is in phase loss, then it enters into the step S102A: the equipment-side control device controls the step speed and the forward/reverse rotation according to the detection of the positive half-cycle phase loss time or its frequency; and enters into the step S105: the ceiling fan brushless motor operates according to the controlled speed and the direction of forward/reverse rotation; if the positive half-cycle phase loss is not detected, then enters into the step S103: the wire-controlled circuit control device controls the control key unit to control the negative half-cycle of the step speed and whether it is in phase loss or not; if the negative half-cycle phase loss is detected, then enters into the step S103A: the equipment-side control device controls the step speed and the forward/reverse rotation according to the detection of the negative half-cycle phase loss time or its frequency; and enters into the step S105: the ceiling fan brushless motor operates according to the controlled speed and the direction of forward/reverse rotation; if the negative half-cycle phase loss is not detected, then enter into the step S104: the equipment-side control device controls the step speed and direction of forward/reverse rotation according to the memory; and enter into the step S105: the ceiling fan brushless motor operates according to the controlled speed and direction of forward/reverse rotation. The overall arrangement is simplified and convenient, without the need for complicated and cumbersome wiring, to achieve favorable structural stability and convenience in use.

Please refer to FIGS. 2 to 5, which are the reference diagrams of the state of the detailed composition, the control flow, the detection of positive/negative half-cycle and phase loss cooperated with the counting of the normal operation of the wire-controlled circuit control device and the equipment-side control device, and the detection of positive/negative half-cycle and phase loss cooperated with the time interval of the normal operation of the wire-controlled circuit control device and the equipment-side control device of the present invention. In a preferred embodiment, the wire-controlled microcontroller unit 11 of the wire-controlled circuit control device 10 is an MCU (Microcontroller Unit), and the wire-controlled microcontroller unit 11 is a microcomputer integrated with a central processor, a memory, etc., enabling the conduction and interruption of the positive or negative half-cycle power supply to be controlled for the current or voltage after the current/voltage inputs to the wire-controlled circuit control device 10 from the AC power supply 100. This effectively simplifies the complexity of the wiring and increases the multi-applicability of the present invention.

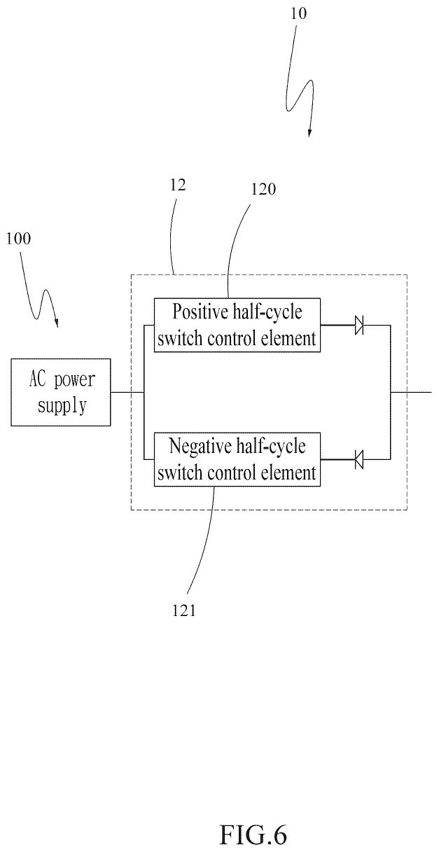

Please refer to FIGS. 2 and 6, which are the reference diagrams of the state of the detailed composition and the first embodiment of the positive/negative half-cycle control unit having a positive half-cycle switching control element and a negative half-cycle switching control element cooperated with a relay and a diode provided in the wire-controlled circuit control device of the present invention. In a preferred embodiment, the positive/negative half-cycle control unit 12 of the wire-controlled circuit control device 10 is provided with a positive half-cycle switch control element 120 and a negative half-cycle switch control element 121, wherein the positive half-cycle switch control element 120 and the negative half-cycle switch control element 121 are cooperated with a relay and a diode and electrically connected to the AC power supply 100. This enables positive or negative half-cycle power supply conduction and interruption to be controlled for the current or voltage without the need for control by complicated wiring, thereby increasing the multi-applicability of the present invention.

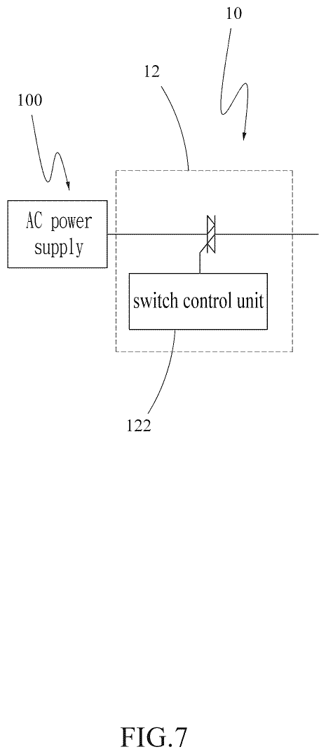

Please refer to FIGS. 2 and 7, which are the reference diagrams of the state of the detailed composition and the second embodiment of a switching control unit being a bidirectional thyristor (TRIAC) according to the present invention. In a preferred embodiment, the positive/negative half-cycle control unit 12 of the wire-controlled circuit control device 10 is provided with a switch control unit 122, which is a bidirectional thyristor (TRIAC) and is electrically connected to the AC power supply 100. This enables positive or negative half-cycle power supply conduction and interruption to be controlled for the current or voltage without the need for control by complicated wiring, thereby increasing the multi-applicability of the present invention.

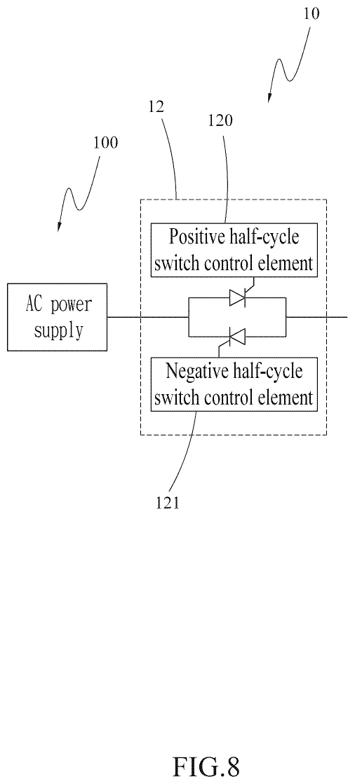

Please refer to FIG. 8, which is a reference diagram of the state for the third embodiment of the control device for adjusting step speed and forward/reverse rotation of a wire-controlled brushless motor power supply during positive/negative half-cycle phase loss of the present invention, illustrating a switch control unit comprising a silicon-controlled rectifier (SCR). In a preferred embodiment, the positive/negative half-cycle control unit 12 of the wire-controlled circuit control device 10 is provided with a positive half-cycle switch control element 120 and a negative half-cycle switch control element 121, wherein the positive half-cycle switch control element 120 and the negative half-cycle switch control element 121 are silicon-controlled rectifier (SCR) switches, and are electrically connected to the AC power supply 100. This enables positive or negative half-cycle power supply conduction and interruption to be controlled for current or voltage without the need for control by complicated wiring, thereby increasing the multi-applicability of the present invention.

Please refer to FIGS. 2 to 5, which are the reference diagrams of the state of the detailed composition, the control flow, the detection of positive/negative half-cycle and phase loss cooperated with the counting of the normal operation of the wire-controlled circuit control device and the equipment-side control device, and the detection of positive/negative half-cycle and phase loss cooperated with the time interval of the normal operation of the wire-controlled circuit control device and the equipment-side control device of the present invention. In a preferred embodiment, the equipment-side microcontroller unit 21 of the equipment-side control device 20 is a microcontroller unit (MCU), and the equipment-side microcontroller unit 21 is a microcomputer integrated with a central processor, a memory, a timer/counter, etc., which receives positive/negative half-cycle phase loss signals from the wire-controlled circuit control device 10 and cooperates with the timing or interval signals generated by the timer/counter to perform an interpretation and to form the multi-step speed control signals or forward/reverse rotation control signals for storage, which are used to control the switching of the step speed and the forward/reverse rotation of the ceiling fan brushless motor 30 by the control signals, thereby effectively simplifying the complexity of the wiring and increasing the multi-applicability of the present invention.

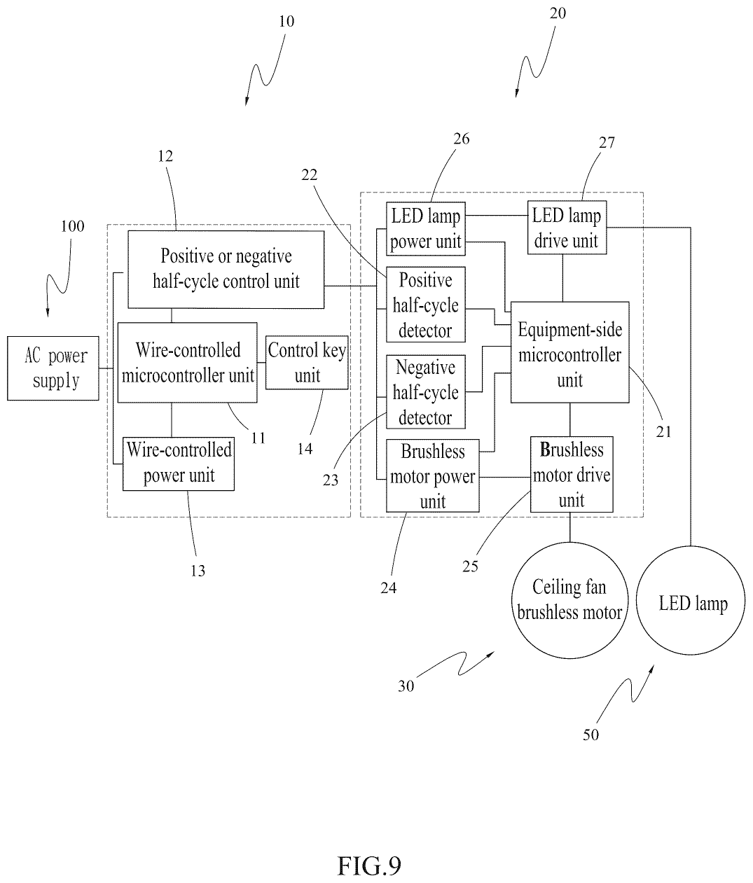

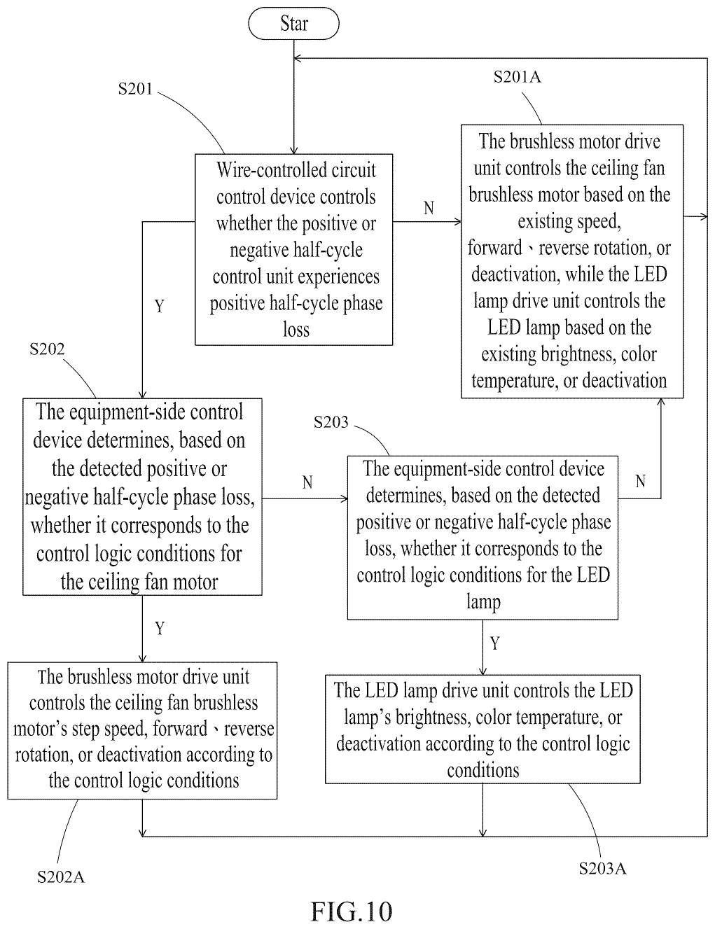

Please refer to FIGS. 9 and 10, which are reference diagrams of the state for the fourth embodiment of the control device for adjusting step speed and forward/reverse rotation of a wire-controlled brushless motor power supply during positive/negative half-cycle phase loss and its control method, illustrating the control state with an additional lamp fixture and the control flow state for the lamp fixture, respectively. The overall structure is identical to that shown in FIGS. 2 to 5 of the present invention, except that it is further applied to an LED lamp 50. The equipment-side control device 20 further includes an LED lamp power unit 26 and an LED lamp drive unit 27, wherein the equipment-side microcontroller unit 21 is further electrically connected to the LED lamp power unit 26 and the LED lamp drive unit 27, and the LED lamp power unit 26 is electrically connected to the LED lamp drive unit 27, which is further electrically connected to the LED lamp 50. Through the wire-controlled microcontroller unit 11 of the wire-controlled circuit control device 10, control logic conditions are stored, comprising positive or negative half-cycle phase loss waveforms, phase loss duration, or phase loss frequency, corresponding to LED lamp deactivation, LED lamp brightness variation, and color temperature variation. The equipment-side control device 20 determines whether the LED lamp 50 is powered on. If it detects that the LED lamp is not powered on, the LED lamp drive unit 27 is deactivated. Upon operating the control key unit 14 to select control commands for LED lamp brightness variation and color temperature variation, the wire-controlled circuit control device 10, via the wire-controlled microcontroller 11, correlates the input AC power with the stored control logic conditions for LED lamp brightness and color temperature variation, and selects the control logic conditions for LED lamp brightness and color temperature variation, corresponding to control signals of positive or negative half-cycle phase loss waveforms, phase loss duration, or phase loss frequency. These control signals are transmitted to the positive or negative half-cycle control unit 12, and the control signals of positive or negative half-cycle phase loss waveforms, phase loss duration, or phase loss frequency are passed through the positive half-cycle detector 22 and negative half-cycle detector 23 of the equipment-side control device 20 to the equipment-side microcontroller unit 21 for signal confirmation. The confirmed control signals are transmitted to the LED lamp drive unit 27 to control the LED lamp 50's brightness variation and color temperature variation. The control method operates as follows: upon initiation, proceed to step S201 where the control key unit of the wire-controlled circuit control device controls whether the positive or negative half-cycle control unit experiences positive or negative half-cycle phase loss; if the positive half-cycle detector detects positive half-cycle phase loss or the negative half-cycle detector detects negative half-cycle phase loss, the wire-controlled circuit control device determines to proceed to step S202 or step S203. In step S202, the equipment-side control device determines, based on the detected positive or negative half-cycle phase loss, whether it corresponds to the control logic conditions for the ceiling fan motor; if it corresponds to the ceiling fan motor's control logic conditions, proceed to step S202A where the brushless motor drive unit controls the ceiling fan brushless motor's step speed, forward/reverse rotation, or deactivation according to the control logic conditions. In step S203, the equipment-side control device determines, based on the detected positive or negative half-cycle phase loss, whether it corresponds to the control logic conditions for the LED lamp; if it corresponds to the LED lamp's control logic conditions, proceed to step S203A where the LED lamp drive unit controls the LED lamp's brightness, color temperature, or deactivation according to the control logic conditions. If neither the positive half-cycle detector detects positive half-cycle phase loss nor the negative half-cycle detector detects negative half-cycle phase loss, the wire-controlled circuit control device proceeds to step S201A, where the brushless motor drive unit controls the ceiling fan brushless motor based on the existing speed, forward/reverse rotation, or deactivation, while the LED lamp drive unit controls the LED lamp based on the existing brightness, color temperature, or deactivation, thereby enhancing the overall applicability of the device and increasing the multi-applicability of the present invention.

Based on the foregoing, the present invention can indeed achieve the above functions and purposes, therefore the present invention meets the requirements for a patent application, and the application is hereby filed by the law.

What is claimed is:

1. A control device for adjusting speed and forward/reverse rotation of a wire-controlled brushless motor power supply during positive/negative half-cycle phase loss of an AC power supply, which is applied to the AC power supply and a ceiling fan brushless motor, comprising:
a wire-controlled circuit control device, which is provided with a wire-controlled microcontroller unit, a positive/negative half-cycle control unit, a wire-controlled power unit, and at least one control key unit, wherein the wire-controlled microcontroller unit is electrically connected to the positive/negative half-cycle control unit, the wire-controlled power unit, and the control key unit, respectively, and wherein the AC power supply is electrically connected to the positive/negative half-cycle control unit, and the wire-controlled power unit of the wire-controlled circuit control device; and
an equipment-side control device configured to determine whether to enable power to the brushless motor of a ceiling fan, which is provided with an equipment-side microcontroller unit, a positive half-cycle detector, a negative half-cycle detector, a brushless motor power unit, and a brushless motor drive unit, wherein the equipment-side microcontroller unit is electrically connected to the positive half-cycle detector, the negative half-cycle detector, and the brushless motor drive unit, respectively, and the brushless motor power unit is electrically connected to the positive half-cycle detector, the negative half-cycle detector, and the equipment-side microcontroller unit, respectively, and wherein the positive half-cycle detector, the negative half-cycle detector, the positive/negative half-cycle control unit of the wire-controlled circuit control device are electrically connected, the brushless motor power unit, the equipment-side microcontroller unit, and the brushless motor drive unit are electrically connected, and the brushless motor drive unit and the ceiling fan brushless motor are electrically connected;
by using the wire-controlled microcontroller unit of the wire-controlled circuit control device, control logic conditions are stored, comprising positive or negative half-cycle phase loss waveforms, phase loss duration, or phase loss frequency, corresponding to step speed and forward/reverse rotation control; upon operating the control key unit to select control commands for step speed and forward/reverse rotation, the wire-controlled circuit control device, via the wire-controlled microcontroller, correlates the input AC power with the stored control logic conditions for step speed and forward/reverse rotation, and selects the control logic conditions for step speed and forward/reverse rotation, corresponding to control signals of positive or negative half-cycle phase loss waveforms, phase loss duration, or phase loss frequency; these control signals are transmitted to the positive or negative half-cycle control unit, and the control signals of positive or negative half-cycle phase loss waveforms, phase loss duration, or phase loss frequency are passed through the positive half-cycle detector and negative half-cycle detector of the equipment-side control device to the equipment-side microcontroller unit for signal confirmation; the confirmed control signals are transmitted to the brushless motor drive unit to control the step speed and forward/reverse rotation of the ceiling fan brushless motor.

2. The control device for adjusting speed and forward/reverse rotation of a wire-controlled brushless motor power supply during positive/negative half-cycle phase loss according to claim 1, wherein, the wire-controlled microcontroller unit of the wire-controlled circuit control device is an MCU (Microcontroller Unit), and the wire-controlled microcontroller unit is a microcomputer integrated with a central processor and a memory, which enables storage of the positive/negative half-cycle signals for controlling anon/off after the current/voltage in the AC power supply inputs to the wire-controlled circuit control device.

3. The control device for adjusting speed and forward/reverse rotation of a wire-controlled brushless motor power supply during positive/negative half-cycle phase loss according to claim 1, wherein, the positive/negative half-cycle control unit of the wire-controlled circuit control device is provided with a positive half-cycle switch control element and a negative half-cycle switch control element, wherein the positive half-cycle switch control element and the negative half-cycle switch control element are cooperated with a relay and a diode, which enables the control of on/off input signals from current/voltage of the AC power supply.

4. The control device for adjusting speed and forward/reverse rotation of a wire-controlled brushless motor power supply during positive/negative half-cycle phase loss according to claim 1, wherein, the positive/negative half-cycle control unit of the wire-controlled circuit control device is provided with a switch control unit, which is a bidirectional thyristor (TRIAC), and which enables the control of on/off input signal from current/voltage of the AC power supply.

5. The control device for adjusting speed and forward/reverse rotation of a wire-controlled brushless motor power supply during positive/negative half-cycle phase loss according to claim 1, wherein the positive/negative half-cycle control unit of the wire-controlled circuit control device is provided with a positive half-cycle control element and a negative half-cycle control element, wherein the positive half-cycle control element and the negative half-cycle control element are silicon-controlled rectifier (SCR) switches, capable of controlling the conduction and interruption input signals of the current or voltage of the AC power supply.

6. The control device for adjusting speed and forward/reverse rotation of a wire-controlled brushless motor power supply during positive/negative half-cycle phase loss according to claim 1, wherein, the equipment-side microcontroller unit of the equipment-side control device is a microcontroller unit (MCU), and the equipment-side microcontroller unit is a microcomputer integrated with a central processor, a memory, and a timer/counter, which receives positive/negative half-cycle phase loss signals from the wire-controlled circuit control device and is cooperated with a timing or interval signals generated by a timer/counter to perform an interpretation and to form a multi-step speed control signals or forward/reverse rotation control signals for storage, which are used to control a switching of the step speed and the forward/reverse rotation of the ceiling fan brushless motor by the control signals.

7. The control device for adjusting speed and forward/reverse rotation of a wire-controlled brushless motor power supply during positive/negative half-cycle phase loss according to claim 1, wherein, the AC power supply inputs a current/voltage in the power source to the wire-controlled circuit control device to control the positive/negative half-cycle on/off of the AC power supply; and a positive/negative half-cycle phase loss signals derived from the wire control circuit control device is detected by the equipment-side control device and interpreted in accordance with a length of the positive half-cycle loss time only or a frequency of the positive half-cycle loss time only, and a length of the negative half-cycle loss time only or a frequency of the negative half-cycle loss time only, to generate control information of the multi-step speed or forward/reverse rotation setting for memory storage; and the equipment-side control device generates the control signals and transmits the control signals to the ceiling fan brushless motor to perform the multi-step speed and forward/reverse rotation control.

8. The control device for adjusting speed and forward/reverse rotation of a wire-controlled brushless motor power supply during positive/negative half-cycle phase loss according to claim 1, wherein the device is further applied to an LED lamp, the equipment-side control device further comprising an LED lamp power unit and an LED lamp drive unit, wherein the equipment-side microcontroller unit is further electrically connected to the LED lamp power unit and the LED lamp drive unit, and the LED lamp power unit is electrically connected to the LED lamp drive unit, which is further electrically connected to the LED lamp; through the wire-controlled microcontroller unit of the wire-controlled circuit control device, control logic conditions are stored, comprising positive or negative half-cycle phase loss waveforms, phase loss duration, or phase loss frequency, corresponding to LED lamp deactivation, LED lamp brightness variation, and color temperature variation; upon operating the control key unit to select control commands for LED lamp brightness variation and color temperature variation, the wire-controlled circuit control device, via the wire-controlled microcontroller, correlates the input AC power with the stored control logic conditions for LED lamp brightness and color temperature variation, and selects the control logic conditions for LED lamp brightness and color temperature variation, corresponding to control signals of positive or negative half-cycle phase loss waveforms, phase loss duration, or phase loss frequency; these control signals are transmitted to the positive or negative half-cycle control unit, and the control signals of positive or negative half-cycle phase loss waveforms, phase loss duration, or phase loss frequency are passed through the positive half-cycle detector and negative half-cycle detector of the equipment-side control device to the equipment-side microcontroller unit for signal confirmation; the confirmed control signals are transmitted to the LED lamp drive unit to control the LED lamp's brightness variation and color temperature variation.

9. The control device for adjusting speed and forward/reverse rotation of a wire-controlled brushless motor power supply during positive/negative half-cycle phase loss according to claim 8, wherein the control method operates as follows: upon initiation, proceed to step S201 where the control key unit of the wire-controlled circuit control device controls whether the positive or negative half-cycle control unit experiences positive or negative half-cycle phase loss; if the positive half-cycle detector detects positive half-cycle phase loss or the negative half-cycle detector detects negative half-cycle phase loss, the wire-controlled circuit control device determines to proceed to step S202 or step S203; in step S202, the equipment-side control device determines, based on the detected positive or negative half-cycle phase loss, whether the phase loss corresponds to the control logic conditions for the ceiling fan motor; if the conditions correspond to the ceiling fan unit controls the ceiling fan brushless motor's speed, forward/reverse rotation, or deactivation according to the control logic conditions; in step S203, the equipment-side control device determines, based on the detected positive or negative half-cycle phase loss, whether the phase loss corresponds to the control logic conditions for the LED lamp; if the conditions correspond to the LED lamp's control logic conditions, proceed to step S203A where the LED lamp drive unit controls the LED lamp's brightness, color temperature, or deactivation according to the control logic conditions; if neither the positive half-cycle detector detects positive half-cycle phase loss nor the negative half-cycle detector detects negative half-cycle phase loss, the wire-controlled circuit control device proceeds to step S201A, where the brushless motor drive unit controls the ceiling fan brushless motor based on the existing speed, forward/reverse rotation, or deactivation, while the LED lamp drive unit controls the LED lamp based on the existing brightness, color temperature, or deactivation.
